(19) United States
(12) Patent Application Publication
(10) Pub. No.: US 2010/0333027 A1
(43) Pub. Date: Dec. 30, 2010

(54) DELETE SLIDER MECHANISM

(75) Inventors: Joakim Martensson, Lund (SE); Dan Gavie, Malmo (SE)

Correspondence Address: HARRITY & HARRITY, LLP, 11350 RANDOM HILLS ROAD, SUITE 600, FAIRFAX, VA, 22030, US

(73) Assignee: Sony Ericsson Mobile Communications AB, Lund (SE)

(21) Appl. No.: 12/492,587

(22) Filed: Jun. 26, 2009

(51) Int. Cl. G06F 3/048

(52) U.S. Cl. 715/833

(57) ABSTRACT

A device provides a delete slider icon, receives one or more characters, and selects a delete function from multiple delete functions, based on user activity associated with the delete slider icon. The device also deletes a single character of the one or more characters when a tap on the delete slider icon is detected, deletes one or more of the one or more characters when the delete slider icon is dragged over the one or more characters and released, and deletes all of the one or more characters when a flicking of the delete slider icon is detected.

### BACKGROUND

Many electronic devices provide an option to a user to enter characters. For example, a mobile communication device (e.g., a cell phone) may use an input device, such as a keypad or a touch screen for receiving user input. A keypad may send a signal to the device when a user pushes a button on the keypad. A touch screen may send a signal to the device when a user touches it with a finger or a pointing device, such as a stylus. When a user inputs characters, the characters may appear on a display device of the mobile device. Users may make mistakes or change their mind about characters that have been entered through the input device. Additionally, some electronic devices, such as mobile communication devices, may have limited space available for an input device and an output device. Removing incorrect characters in an efficient manner, given such limitations, may prove to be troublesome to users of such electronic devices.

### SUMMARY

According to one aspect, a device may include a memory to store a plurality of instructions; and a processor to execute instructions in the memory to provide, to a user, a delete slider icon, detect user activity associated with the delete slider icon, and determine one of a plurality of delete functions to activate based on the user activity, where the plurality of delete functions include at least two of a tap to delete function that deletes a single character in response to the user tapping the delete slider icon, a delete on release function that deletes one or more characters in response to the user dragging the delete slider icon over the one or more characters and releasing the delete slider icon, or a flick to delete function that deletes all displayed characters in response to the user flicking the delete slider icon.

Additionally, the delete slider icon may be provided inside a character entry box.

Additionally, the delete slider icon may disappear if there are no characters in the character entry box.

Additionally, the character entry box may display multiple rows of text.

Additionally, the delete on release function may be implemented to delete multiple rows of text with one dragging motion.

Additionally, the appearance of the delete slider icon may change based on the delete function being activated.

Additionally, each of the plurality of delete functions may be activated with a single movement of the delete slider icon.

Additionally, the delete slider mechanism may include a touch screen to display the delete slider icon and to receive input from the user associated with the delete slider icon.

According to another aspect, a method, performed by a mobile communication device, may include providing, by an output device of the mobile communication device, a delete slider icon; receiving, by an input device of the mobile communication device, one or more characters; selecting, by a processor of the mobile communication device, a delete function from a plurality of delete functions, based on user activity associated with the delete slider icon; deleting, by the processor, a single character of the one or more characters when a tap on the delete slider icon is detected; deleting, by the processor, one or more of the one or more characters when the delete slider icon is dragged over the one or more characters and released; and deleting, by the processor, all of the one or more characters when a flicking of the delete slider icon is detected.

Additionally, the method may include providing a different audible signal for each of the plurality of delete functions.

Additionally, an appearance of the delete slider icon may change based on the selected delete function.

Additionally, detection of the flicking of the delete slider icon may include detecting a speed associated with a movement of the delete slider icon, and detecting a distance associated with the movement of the delete slider icon before detecting a release of the delete slider icon.

Additionally, detecting a speed associated with the movement of the delete slider icon may include detecting that the speed is greater than a first threshold and detecting a distance associated with the movement of the delete slider icon may include detecting that the distance is less than a second threshold.

Additionally, the method may include providing a character entry box and where providing the delete slider icon comprises providing the delete slider icon inside the character entry box.

Additionally, the character entry box may display multiple rows of text.

Additionally, deleting one or more of the one or more characters may include deleting multiple rows of text based on a single dragging motion.

According to yet another aspect, a computer-readable medium may include one or more instructions to provide a delete slider icon; one or more instructions to receive one or more characters; one or more instructions to select a delete function based on user activity associated with the delete slider icon; one or more instructions to delete a single character of the one or more characters when a tap on the delete slider icon is detected; one or more instructions to delete one or more of the one or more characters when the delete slider icon is dragged over the one or more characters and released; and one or more instructions to delete all of the one or more characters, when a flicking of the delete slider icon is detected.

Additionally, the computer-readable medium may include one or more instructions to remove the delete slider icon if all the received one or more characters are deleted.

Additionally, the computer-readable medium may include one or more instructions to provide an animation of the delete slider icon returning to an original position after deleting at least two characters in a single action.

Additionally, the computer-readable medium may include one or more instruction to provide an animation of the delete slider icon disappearing after deleting all of the one or more characters.

### BRIEF DESCRIPTION OF THE DRAWINGS

The accompanying drawings, which are incorporated in and constitute a part of this specification, illustrate one or more systems and/or methods described herein and, together with the description, explain these systems and/or methods. In the drawings:

FIG. 1 is a diagram of an exemplary mobile communication device in which systems and/or methods described herein may be implemented;

FIG. 2 is a diagram illustrating exemplary components of the mobile communication device of FIG. 1;

FIG. 3 is a diagram of exemplary components of a delete slider mechanism described herein;

FIG. 4 is a diagram of an exemplary user interface capable of being provided by the mobile communication device depicted in FIG. 1;

FIG. 5 is a flow graph of an exemplary process for implementing a delete slider process;

FIGS. 6A and 6B illustrate a flow graph of an exemplary process for implementing a tap to delete function with the mobile communication device depicted in FIG. 1;

FIGS. 7A and 7B illustrate a flow graph of a first exemplary process for implementing a delete on release function with the mobile communication device depicted in FIG. 1;

FIGS. 8A and 8B illustrate a flow graph of a second exemplary process for implementing a delete on release function with the mobile communication device depicted in FIG. 1; and

FIGS. 9A and 9B illustrate a flow graph of an exemplary process for implementing a flick to delete function with the mobile communication device depicted in FIG. 1.

### DETAILED DESCRIPTION

The following detailed description refers to the accompanying drawings. The same reference numbers in different drawings identify the same or similar elements. Also, the following detailed description does not limit the invention.

Exemplary implementations described herein may be described in the context of a mobile communication device (or mobile terminal). A mobile communication device is an example of a device that can employ an input device described herein, and should not be construed as limiting of the types or sizes of devices or applications that can include the input device described herein. For example, the input devices described herein may be used with a desktop device (e.g., a personal computer or workstation), a laptop computer, a personal digital assistant (PDA), a media playing device (e.g., an MPEG audio layer 3 (MP3) player, a digital video disc (DVD) player, a video game playing device), a household appliance (e.g., a microwave oven and/or appliance remote control), an automobile radio faceplate, a television, a computer screen, a point-of-sale terminal, an automated teller machine, an industrial device (e.g., test equipment, control equipment), or any other device that may utilize an input device.

When using a mobile communication device, users may enter characters using an input device of the mobile communication device. For example, a user may enter the digits of a phone number using a keypad or a touch screen. The user may decide that one or more of the entered characters are incorrect and the user may therefore delete the incorrect characters. The mobile communication device may include a delete button. However, the delete button may be a cumbersome method of deleting multiple characters, because the delete button must be pressed once for each incorrect character that the user would like to delete.

A delete slider mechanism, as described herein, may provide multiple delete functions. The delete slider mechanism may provide a convenient and efficient method of deleting multiple characters using an icon on a display device (i.e. a screen) of a mobile communication device. The delete slider mechanism may provide a tap to delete function, which may allow a user to delete a single character by tapping a delete slider icon on the screen. The delete slider mechanism may provide a delete on release function, which may allow a user to delete multiple characters by sliding, using a finger or a pointing device, a delete slider icon over characters and releasing the finger or pointing device. The delete on release function may allow a user to delete multiple rows of characters with one motion. The delete slider mechanism may include a flick to release function, which may allow a user to delete multiple characters with a flicking motion of a finger or pointing device.

### Exemplary Device

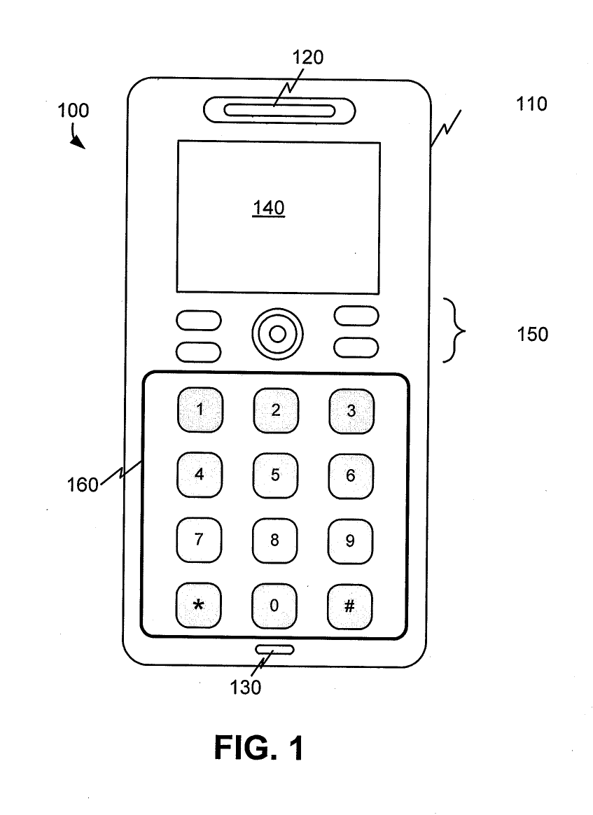

FIG. 1 is a diagram of an exemplary mobile communication device 100 in which systems and/or methods described herein may be implemented. As shown, mobile communication device 100 may include a cellular radiotelephone with or without a multi-line display; a personal communications system (PCS) terminal that may combine a cellular radiotelephone with data processing, facsimile and data communications capabilities; a PDA that may include a radiotelephone, pager, Internet/Intranet access, Web browser, organizer, calendar and/or a global positioning system (GPS) receiver; a laptop and/or palmtop receiver; or other appliances that include a radiotelephone transceiver. Mobile communication device 100 may also include media playing capability. As described above, systems and/or methods described herein may also be implemented in other devices that require user input, with or without communication functionality.

Referring to FIG. 1, mobile communication device 100 may include a housing 110, a speaker 120, a microphone 130, a display 140, control buttons or keys 150, and a keypad 160.

Housing 110 may protect the components of mobile communication device 100 from outside elements. Housing 110 may include a structure configured to hold devices and components used in mobile communication device 100, and may be formed from a variety of materials. For example, housing 110 may be formed from plastic, metal, or a composite, and may be configured to support speaker 120, microphone 130, display 140, control buttons or keys 150, and/or keypad 160.

Speaker 120 may provide audible information to a user of mobile communication device 100. Speaker 120 may be located in an upper portion of mobile communication device 100, and may function as an ear piece when a user is engaged in a communication session using mobile communication device 100. Speaker 120 may also function as an output device for music and/or audio information associated with games, voicemails, and/or video images played on mobile communication device 100.

Microphone 130 may receive audible information from the user. Microphone 130 may include a device that converts speech or other acoustic signals into electrical signals for use by mobile communication device 100. Microphone 130 may be located proximate to a lower side of mobile communication device 100.

Display 140 may provide visual information to the user. Display 140 may be a color display, such as a red, green, blue (RGB) display, a monochrome display or another type of display. In one implementation, display 140 may include a touch sensor display or a touch screen that may be configured to receive a user input when the user touches display 140. For example, the user may provide an input to display 140 directly, such as via the user's finger, or via other input objects, such as a stylus. User inputs received via display 140 may be processed by components and/or devices operating in mobile communication device 100. The touch screen display may permit the user to interact with mobile communication device 100 in order to cause mobile communication device 100 to perform one or more operations. In one exemplary implementation, display 140 may include a liquid crystal display (LCD) display. Display 140 may include a driver chip (not shown) to drive the operation of display 140.

Control buttons 150 may permit the user to interact with mobile communication device 100 to cause mobile communication device 100 to perform one or more operations, such as place a telephone call, play various media, etc. For example, control buttons 150 may include a dial button, a hang up button, a play button, etc.

Keypad 160 may include a telephone keypad used to input information into mobile communication device 100.

In an exemplary implementation, control buttons 150 and/or keypad 160 may be part of display 140. Display 140, control buttons 150, and keypad 160 may be part of an optical touch screen display. In addition, in some implementations, different control buttons and keypad elements may be provided based on the particular mode in which mobile communication device 100 is operating. For example, when operating in a cell phone mode, a telephone keypad and control buttons associated with dialing, hanging up, etc., may be displayed by display 140. In other implementations, control buttons 150 and/or keypad 160 may not be part of display 140 (i.e., may not be part of an optical touch screen display).

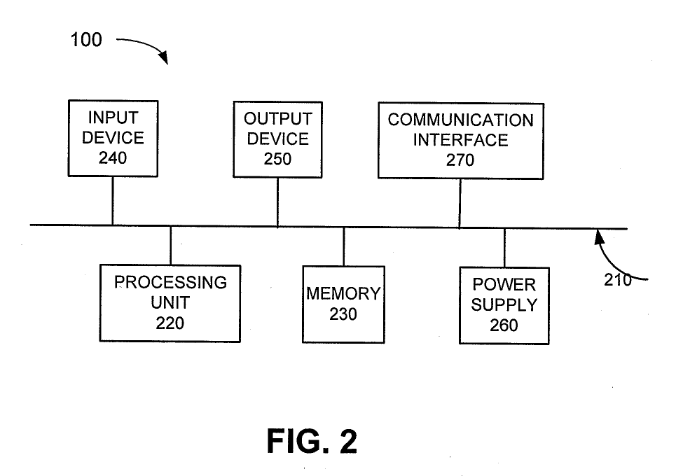

FIG. 2 is a diagram illustrating exemplary components of mobile communication device 100. As shown, mobile communication device 100 may include a bus 210, processing unit 220, memory 230, an input device 240, an output device 250, a power supply 260 and a communication interface 270. Mobile communication device 100 may be configured in a number of other ways and may include other or different elements. For example, mobile communication device 100 may include one or more modulators, demodulators, encoders, decoders, etc., for processing data.

Bus 210 may permit communication among the components of mobile communication device 100.

Processing unit 220 may include one or more processors; microprocessors; application specific integrated circuits (ASICs); field programmable gate arrays (FPGAs); or the like. Processing unit 220 may execute software instructions/programs or data structures to control operation of mobile communication device 100. In an exemplary implementation, processing unit 220 may include logic to control display 140. For example, processing unit 220 may determine whether a user has provided input to a touch screen portion of display 140, as described herein.

Memory 230 may include a random access memory (RAM) or another type of dynamic storage device that may store information and/or instructions for execution by processing unit 220; a read only memory (ROM) or another type of static storage device that may store static information and/or instructions for use by processing unit 220; a flash memory (e.g., an electrically erasable programmable read only memory (EEPROM)) device for storing information and/or instructions; and/or some other type of magnetic or optical recording medium and its corresponding drive. Memory 230 may also be used to store temporary variables or other intermediate information during execution of instructions by processing unit 220. Instructions used by processing unit 220 may also, or alternatively, be stored in another type of computer-readable medium accessible by processing unit 220. A computer-readable medium may be defined as a physical or logical memory device. A logical memory device may include memory space within a single physical memory device or spread across multiple physical memory devices.

Input device 240 may include mechanisms that permit a user to input information to mobile communication device 100, such as microphone 130, touch screen display 140, control buttons 150, keypad 160, a keyboard, a mouse, a pen, voice recognition and/or biometric mechanisms, etc. For example, as discussed above, all or a portion of display 140 may function as a touch screen input device for inputting information to mobile communication device 100.

Output device 250 may include one or more mechanisms that output information from mobile communication device 100, including a display, such as display 140, one or more speakers, such as speaker 120, etc. Power supply 260 may include one or more batteries or other power source components used to supply power to components of mobile communication device 100. Power supply 260 may also include control logic to control application of power from power supply 260 to one or more components of mobile communication device 100.

Power supply 260 may include one or more batteries or other power source components used to supply power to components of mobile communication device 100. Power supply 260 may also include logic to control application of power from power supply 260 to one or more components of mobile communication device 100.

Communication interface 270 may include any transceiver-like mechanism that enables mobile communication device 100 to communicate with other devices and/or systems. For example, communication interface 270 may include a modem or an Ethernet interface to a LAN. Communication interface 270 may also include mechanisms for communicating via a network, such as a wireless network. For example, communication interface 270 may include one or more radio frequency (RF) transmitters, receivers and/or transceivers. Communication interface 270 may also include one or more antennas for transmitting and receiving RF data.

Mobile communication device 100 may provide a platform for a user to make and receive telephone calls, send and receive electronic mail or text messages, play various media, such as music files, video files, multi-media files, or games, and execute various other applications. Mobile communication device 100 may also perform processing associated with display 140 when display 140 operates as a touch screen input device. In an exemplary implementation, mobile communication device 100 may provide the delete slider mechanism described herein. Mobile communication device 100 may perform these operations in response to processing unit 220 executing sequences of instructions contained in a computer-readable storage medium, such as memory 230. Such instructions may be read into memory 230 from another computer-readable medium or another device via, for example, communication interface 270. In alternative embodiments, hard-wired circuitry may be used in place of or in combination with software instructions to implement processes described herein. Thus, implementations described herein are not limited to any specific combination of hardware circuitry and software.

### Exemplary Delete Slider Functionality

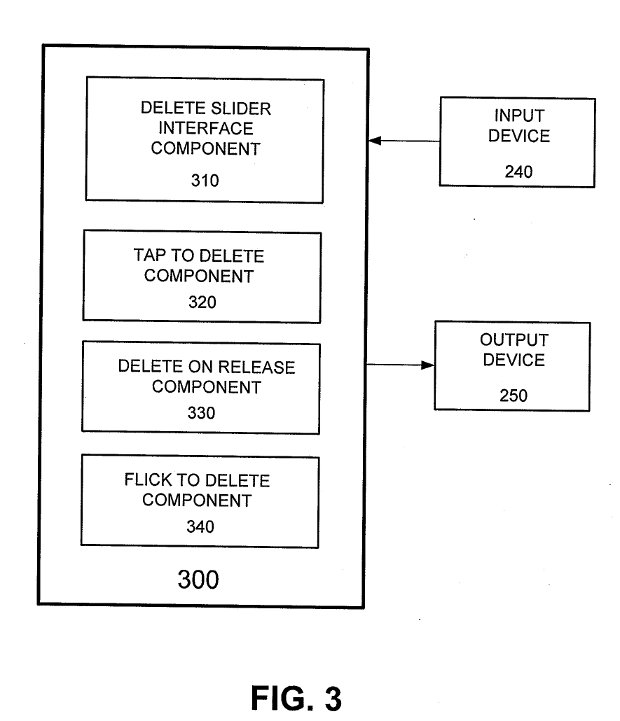

FIG. 3 is a diagram of exemplary components of delete slider functions 300 capable of being provided by mobile communication device 100. In one implementation, delete slider functions 300 may be included in processing unit 220. Delete slider functions 300 may be coupled to input device 240 and output device 250. Delete slider functions 300 may receive input from input device 240, process the input, and provide output, based on the processed input, to output device 250. In one implementation, delete slider functions 300 may include a delete slider interface component 310, a tap to delete component 320, a delete on release component 330, and a flick to delete component 340. In another implementation, delete slider functions 300 may include more or fewer components. In the implementations described herein, output device 250 may include a touch screen. In other implementations of delete slider functions 300, output device 250 may include a device other than a touch screen. In the implementations described herein, the delete slider mechanism interacts with the user via a delete slider icon presented in a character entry box. In other implementation, the delete slider icon may not be presented in a character entry box.

Delete slider interface component 310 may present an interface that allows a user to activate functions implemented by the delete slider mechanism. For example, delete slider interface component 310 may present a delete slider icon for display via a touch screen (i.e., output device 250). Delete slider interface component 310 may detect activation of the delete slider icon. For example, a user may touch the delete slider icon with a finger or a pointing device. In response to detecting that the delete slider icon has been activated by the user, delete slider interface component 310 may detect a type of user action. A user action may include touching and releasing the delete slider icon, moving the delete slider icon in a particular direction and releasing the delete slider, or moving the delete slider in a particular direction with a particular speed. Delete slider interface component 310 may detect other types of user actions. In response to detecting a user action, delete slider interface component 310 may determine the type of user action and activate another component of delete slider functions 300. Delete slider interface component 310 may activate tap to delete component 320, delete on release component 330, or flick to delete component 340.

In response to detecting that the user has touched the delete slider icon and released the delete slider icon, a series of actions also known as a “tap,” delete slider interface component 310 may activate tap to delete component 320. Tap to delete component 320 may implement a tap to delete function. The tap to delete function may delete the last character that was entered by the user via input device 240. Tap to delete component 320 may provide indications to the user, via the touch screen display, that the tap to delete function is being executed.

In response to detecting that the user has touched the delete slider icon and moved the delete slider icon, delete slider interface component may activate delete on release component 330. Delete on release component 330 may implement a delete on release function. The delete on release function may delete characters, being displayed in a character entry box, over which the delete slider icon has been moved and provide indications to the user, via the touch screen display, that the characters are being deleted. When delete on release component 330 detects that the user has released the delete slider icon, delete on release component 330 may provide indications to the user, via the touch screen display, that the delete on release function is being executed.

In response to detecting that the user has flicked the delete slider icon, delete slider interface component 310 may activate flick to delete component 340. A flick action may correspond to a quick sliding movement of the finger or pointing device. Flick to delete component 340 may implement a flick to delete function. The flick to delete function may delete all the characters that were entered by the user and that are currently being displayed in a character entry box displayed on the touch screen display. Flick to delete component 340 may provide indications to the user, via the touch screen display, that the flick to delete function is being executed.

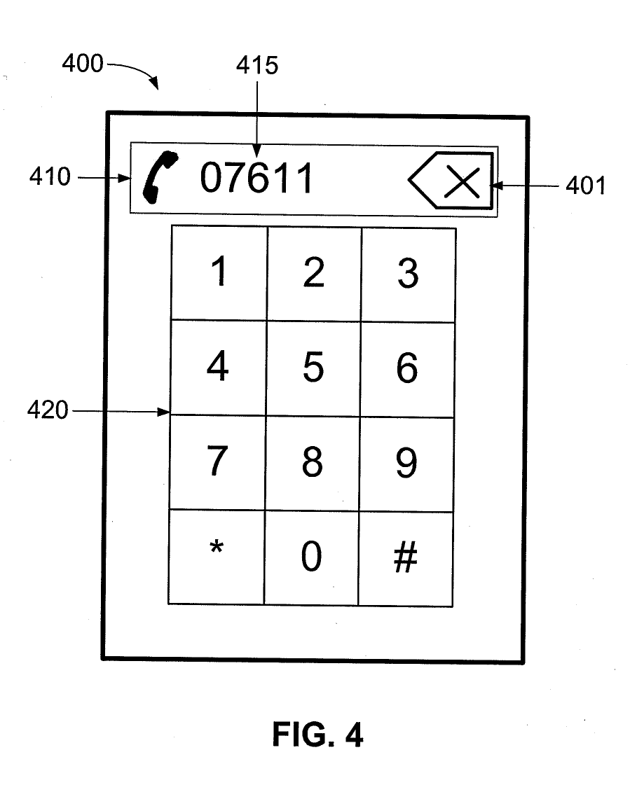

FIG. 4 is a diagram of an exemplary user interface 400 for providing to the user a delete slider icon 401 for implementing delete slider functions 300. User interface 400 may be provided via a touch screen (i.e. output device 250). User interface 400 may include character entry box 410 and touch screen keypad 420.

Character entry box 410 may include characters 415 entered by the user and may include delete slider icon 401. Characters 415 may be entered by the user via touch screen keypad 420. Character entry box 410 may also display characters that were entered by methods other than touch screen keypad, such as via keypad 160, control keys 150, or through audio input via microphone 130. Character entry box 410 may also display characters received via communication interface 270. For example, a user may visit a web page and click on a particular link. By clicking on the link, a phone number may be sent to mobile communication device 100 and mobile communication device 100 may display the received phone number in character entry box 410.

Touch screen keypad 420 may include keys that a user can touch to enter a particular character. While a set of numerical keys is illustrated in FIG. 4, touch screen keypad 420 may include letter keys. Alternatively, or additionally, touch screen keypad 420 may include a full keyboard.

Delete slider icon 401 may be used by the user to activate the functions of delete slider functions 300. In response to the user performing a particular movement, delete slider functions 300 may perform a particular function, and provide indications that the particular function is being executed via delete slider icon 401. For example, delete slider icon 401 may move across character entry box 410 in response to a movement of the user's finger or pointing device. The appearance of delete slider icon 401 may change based on the particular function that is being performed. Any icon may be used as delete slider icon 401. The user may be presented with an option to select a particular icon to represent delete slider icon 410 from a set of icons. Alternately, or additionally, the user may be presented with an option to create a custom icon.

In one implementation, delete slider icon 401 may appear only if there is at least one character present in character entry box 410. If there are no characters in character entry box 410, the delete slider icon may not be displayed. In another implementation, delete slider icon 401 may be displayed even if there are no characters in character entry box 410.

### Exemplary Processes

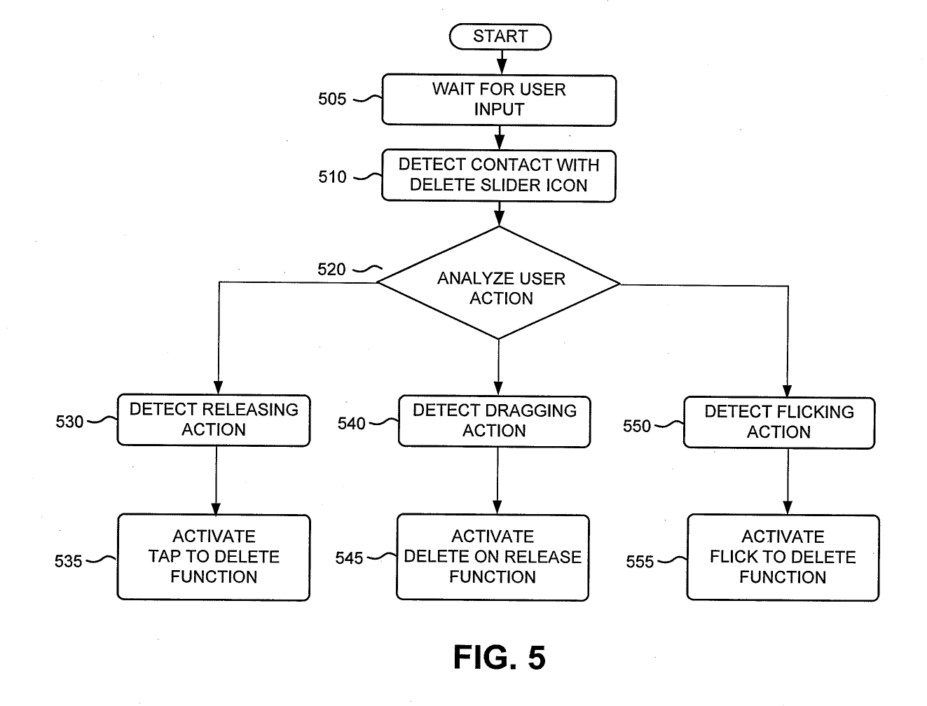

FIG. 5 is a flow diagram illustrating an exemplary process for implementing delete slider functions 300. The process of FIG. 5 may begin with waiting for user input (block 505). Contact with delete slider icon may be detected (block 510). For example, delete slider interface component 310 may detect contact in the area of touch screen 400 corresponding to delete slider icon 401. The user may touch delete slider icon 401 with a finger, or a pointing device, such as a stylus. In one implementation, touch screen 400 may include a capacitive touch screen and contact in the area of touch screen 400 corresponding to delete slider icon 401 may correspond to a particular change in capacitance. Alternatively or additionally, touch screen 400 may include an input device comprising pixels, and contact in the area of touch screen 400 corresponding to delete slider icon 401 may correspond to particular pixels being contacted.

In response to detecting that the user has touched delete slider icon 401, the user's action may be analyzed (block 520). For example, delete slider interface component 310 may determine if the user has released contact with the delete slider icon, moved the delete slider icon in a particular direction, or moved the delete slider icon with a particular speed.

A releasing action may be detected (block 530). For example, delete slider interface component 310 may detect that the user has released the delete slider icon after touching the release slider contact. This series of actions is also known as a tap. In response to detecting that the user has released contact with the delete slider without moving the delete slider, a tap to delete function may be activated (block 535). For example, delete slider interface component 310 may activate tap to delete component 320.

A dragging action may be detected (block 540). For example, delete slider interface component 310 may detect that the user has dragged the delete slider icon after touching the delete slider icon. Dragging may correspond to the user sliding the finger or pointing device without significantly releasing pressure. For example, the user may drag the delete slider icon 401 across character entry box 410 towards characters 415. In response to detecting that the user has begun to drag the delete slider icon, a delete on release function may be activated (block 545). For example, delete slider interface component 310 may activate delete on release component 330.

A flicking action may be detected (block 550). For example, delete slider interface component 310 may detect that the user has flicked the delete slider icon after touching the release slider contact. Flicking may correspond to the user moving the finger or pointing device with a short, quick movement. Flicking may be distinguished from dragging based on speed of the movement and the distance moved before pressure is released. For example, for a movement to be detected as a flicking movement, a user may have to move delete slider icon with a speed faster than a flick speed threshold and release the delete slider icon before the delete slider icon travels a distance less than a flick distance threshold. If a user moves the delete slider icon with a speed greater than the flick speed threshold, but does not release the delete slider icon, the movement may be interpreted as a dragging movement. If the user mover the delete slider icon a distance less than the flick speed threshold and then releases the delete slider icon, but the movement is very slow, the movement may be interpreted as a dragging movement. As an example of a flicking movement, a user may flick the delete slider icon 401 towards characters 415. In response to detecting that the user has flicked the delete slider icon, a flick to delete function may be activated (block 555). For example, delete slider interface component 310 may activate flick to delete component 340.

### Tap to Delete Function

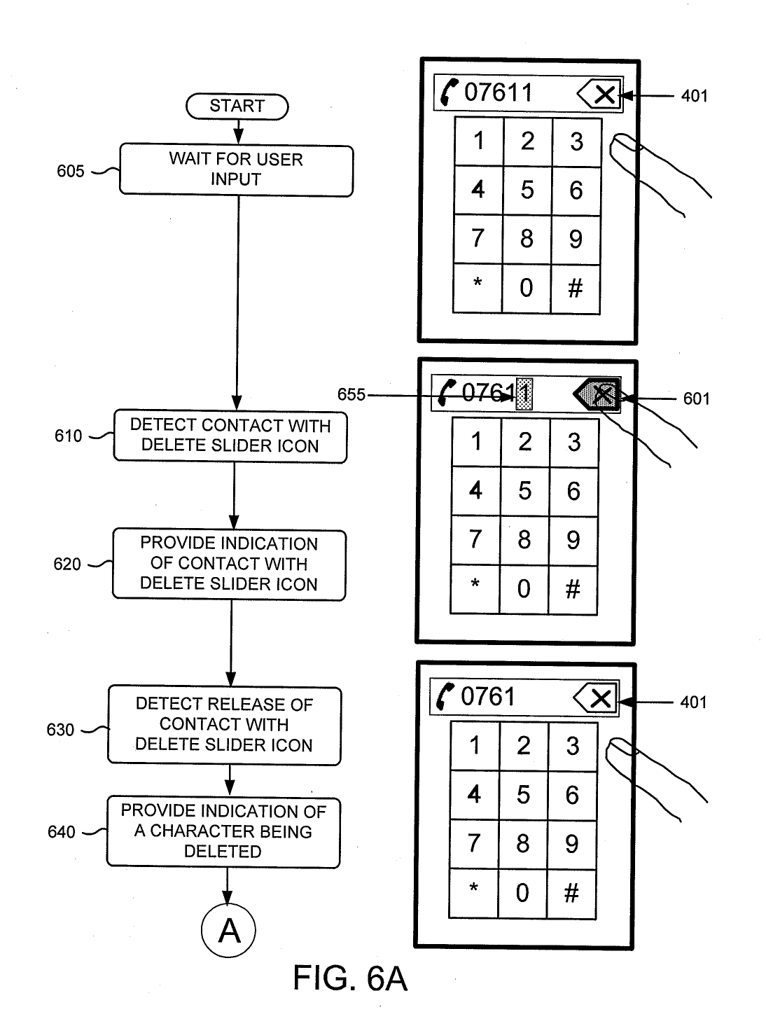

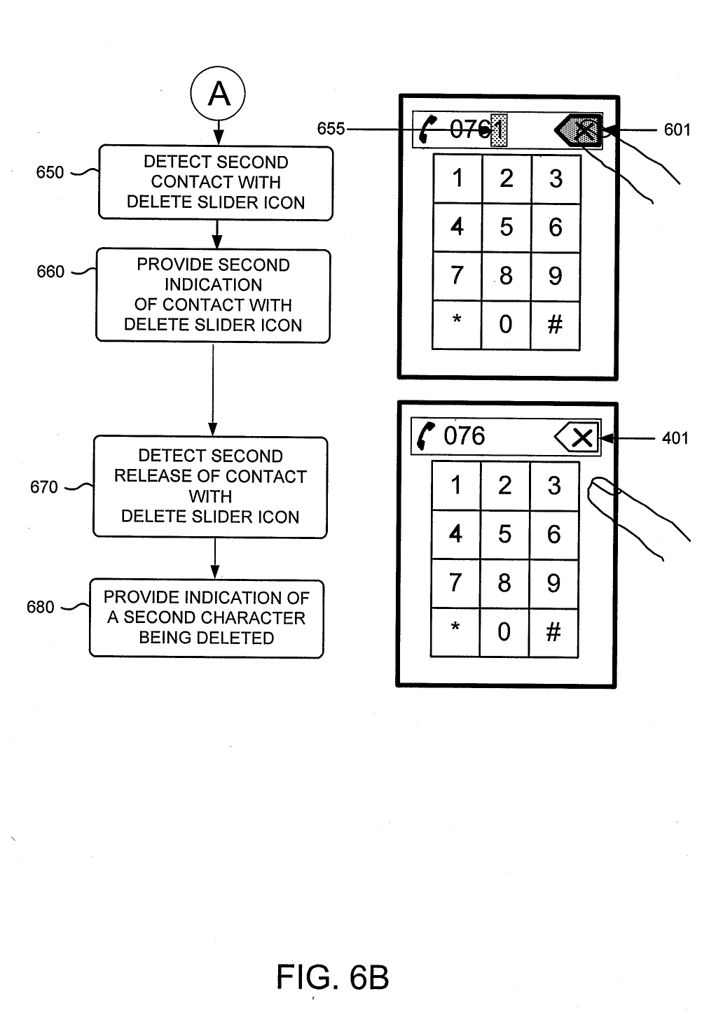

FIGS. 6A and 6B illustrate a flow graph of an exemplary process for implementing a tap to delete component of the delete slider mechanism. The process of FIG. 6A may begin with waiting for user input (block 605). Contact with delete slider icon may be detected (block 610). For example, delete slider interface component 310 may detect contact in the area of touch screen 400 corresponding to delete slider icon 401. Block 605 of FIG. 6A corresponds to block 505 of FIG. 5 and block 610 of FIG. 6A corresponds to block 510 of FIG. 5. Blocks 605 and 610 are included in FIG. 6A for completeness.

In response to detecting contact with the delete slider icon, an indication may be provided of the contact with the delete slider icon (block 620). For example, delete slider interface component 310 may send a signal to the touch screen to change the appearance of delete slider icon 401 to highlighted delete slider icon 601. Alternatively or additionally, a unique audio signal may be provided. Additionally, the last character entered by the user may be highlighted. Highlighted character 655 may indicate that if the user releases highlighted delete slider 601, highlighted character 655 will be deleted.

Release of contact with the delete slider may be detected (block 630). For example, delete slider interface component 310 may detect that contact in the area of touch screen 400 corresponding to the delete slider icon has ended. Delete slider interface component 310 may activate tap to delete component 320. In response to detecting release of contact with delete slider icon, an indication of highlighted character 655 being deleted may be provided (block 640). For example, tap to delete component 320 may remove highlighted character 655 from character entry box 410 and change highlighted delete slider icon 601 to delete slider icon 401 as it appears when a user is not contacting the delete slider icon. Alternatively or additionally, a unique audio signal may be provided.

A user may want to delete a second character. A second contact with the delete slider icon may be detected (block 650). A second indication of contact with delete slider icon may be provided (block 660). For example, delete slider icon 401 may be changed to highlighted delete slider icon 601 and highlight the character that is now the last character in character entry box 410. A second release of contact with the delete slider icon may be detected (block 670) and an indication that a second character was deleted may be provided (block 680).

### Delete on Release Function

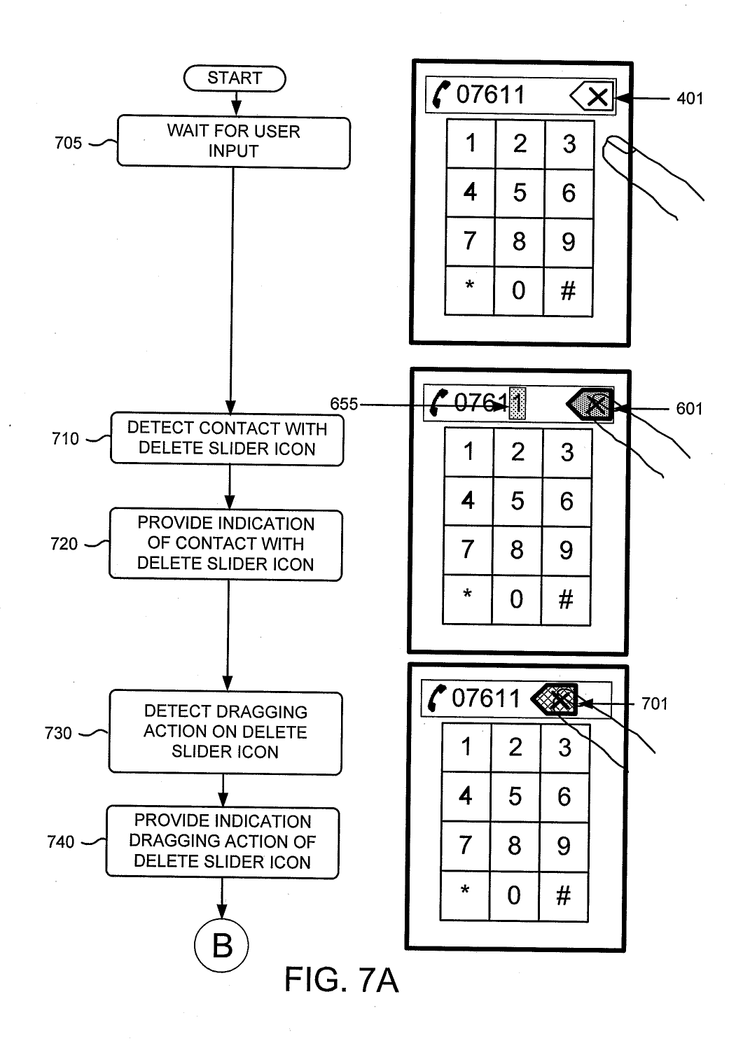

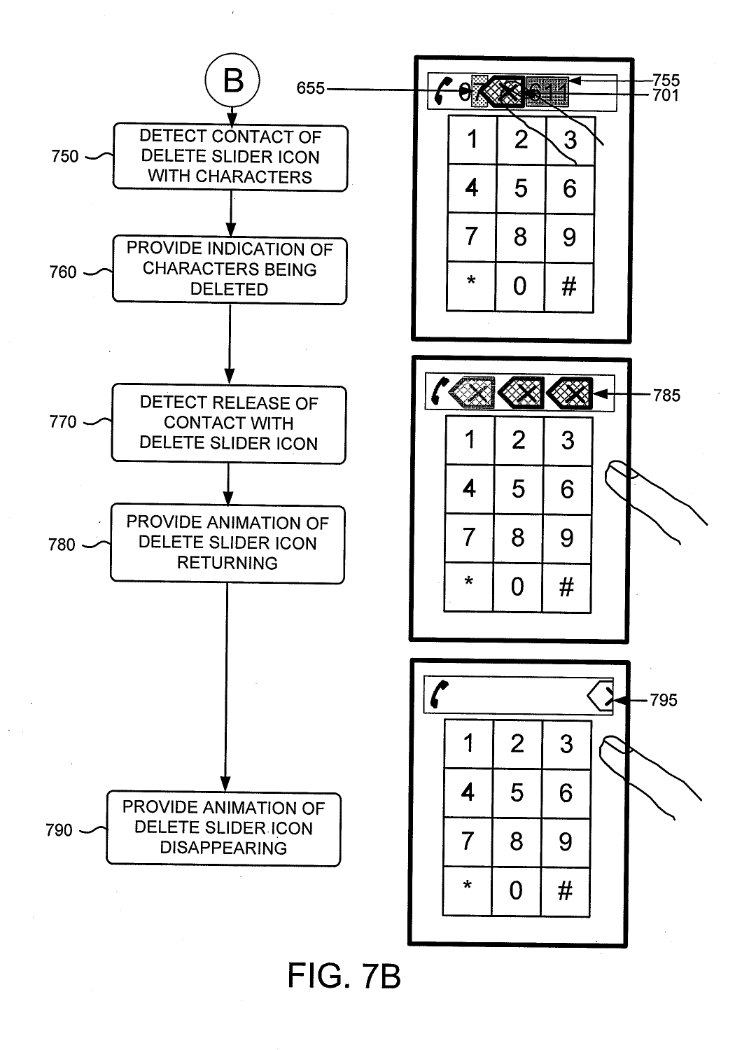

FIGS. 7A and 7B illustrate a flow graph of an exemplary process for implementing a delete on release component of the delete slider mechanism. The process of FIG. 7A may begin with waiting for user input (block 705). Contact with delete slider icon may be detected (block 710). For example, delete slider interface component 310 may detect contact in the area of touch screen 400 corresponding to delete slider icon 401. Block 705 of FIG. 7A corresponds to block 505 of FIG. 5 and block 710 of FIG. 7A corresponds to block 510 of FIG. 5. Blocks 705 and 710 are included in FIG. 7A for completeness.

In response to detecting contact with the delete slider icon, an indication may be provided of the contact with the delete slider icon (block 720). For example, delete slider interface component 310 may send a signal to the touch screen to change the appearance of delete slider icon 401 to highlighted delete slider icon 601. Alternatively or additionally, a unique audio signal may be provided. Additionally, the last character entered by the user may be highlighted. Highlighted character 655 may indicate that if the user releases highlighted delete slider 601, highlighted character 655 will be deleted.

A dragging action may be detected (block 730). For example, delete slider interface component 310 may detect that the user has dragged the delete slider icon after touching the delete slider icon and may activate delete on release component 330. Dragging may correspond to the user sliding the finger or pointing device without significantly releasing pressure. A user may drag the delete slider icon 401 across character entry box 410 towards characters 415. In response to detecting that the user has begun to drag the delete slider icon, an indication of dragging action may be provided (block 740). For example, in one implementation, delete on release component 330 may change highlighted delete slider icon 601 to dragging delete slider icon 701. In another implementation, delete on release component 330 may maintain the appearance of the delete slider icon as highlighted delete icon 601 during the dragging action. Alternatively or additionally, a unique audio signal may be provided. As the user moves the delete slider icon across the display, the position of the delete slider icon is changed accordingly.

Contact of delete slider icon with displayed characters may be detected (block 750). For example, delete on release component 330 may detect that the current position of the delete slider icon coincides with a displayed character. A displayed character that comes in contact with the delete slider may turn into highlighted character 655. An indication of a character being deleted may be provided (block 760). For example, in one implementation, characters that are to be deleted may be moved to the right of delete slider icon 701 and highlighted into highlighted characters to be deleted 755. Thus, characters, over which the delete slider icon is dragged, may jump over to the right of the delete slider icon and may be highlighted. This may allow the user to clearly see which characters will be deleted when the user releases the finger from the delete slider icon. In another implementation, instead of the characters moving to the right of the delete slider icon, delete on release component 330 may remove the characters contacted by the delete slider from character entry box 410.

A character may be turned into highlighted character 655 when a first threshold percentage of the character is covered by the delete slider, and the character may be deleted when a second threshold percentage of the character is covered by the delete slider. For example, delete on release component 330 may highlight the character when the delete slider first contacts the area of the character and may delete the highlighted character when the delete slider covers 50% of the area of the character. Alternatively or additionally, a unique audio signal may be provided.

Release of contact with the delete slider icon may be detected (block 770). For example, delete on release component 330 may detect that contact in the area of touch screen 400 corresponding to dragging delete slider icon 701 has ended. An animation of the delete slider icon returning may be provided (block 780). For example, delete on release component 330 may provide returning delete slider icon animation 785. If all characters have been deleted, an animation of the delete slider icon disappearing may be provided (block 790). For example, delete on release component 330 may provide animation 795 of the delete slider sliding out of sight at the edge of character entry box 410.

In one implementation, if the user does not release the delete slider after moving the delete slider into an area of displayed characters, but moves the delete slider back to the starting position, the deleted characters may reappear. In another implementation, even if the user does not release the delete slider icon, but moves the delete slider back to the starting position, the deleted characters may remained deleted.

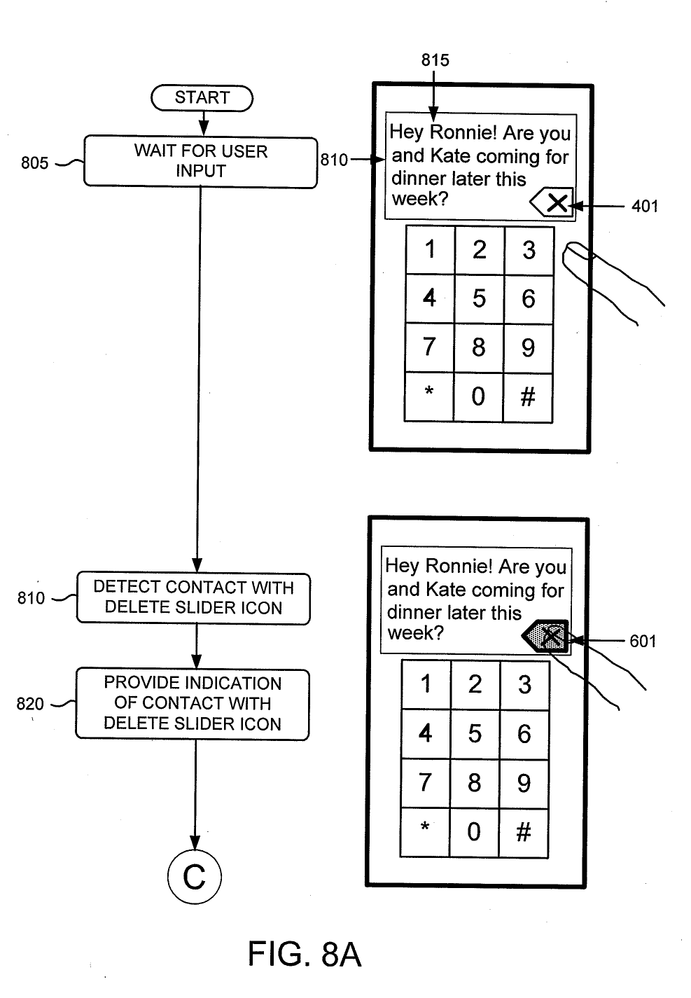

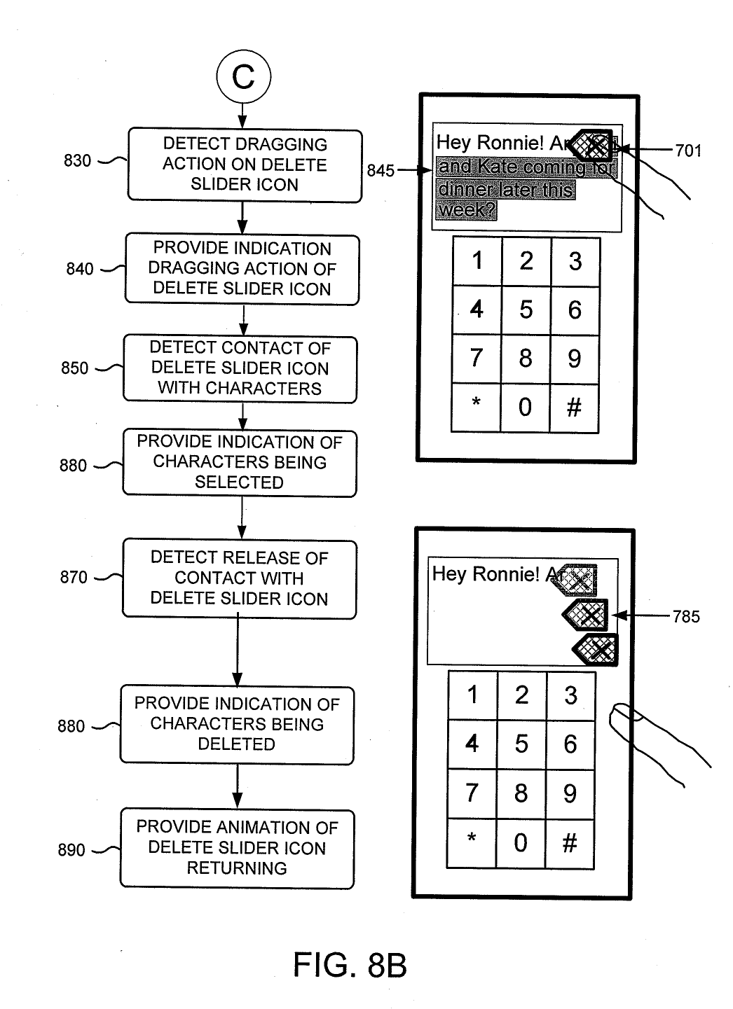

FIGS. 8A and 8B illustrate a flow graph of an exemplary process for deleting multiple rows of text using a delete on release component of the delete slider mechanism. A text entry box 810 may be provided on touch screen 400 that displays multiple rows of characters 815. For example, text entry box 810 may be displayed on touch screen 400 when a user begins to compose a text message, such as a short message service (SMS) message.

The process of FIG. 8A may begin with waiting for user input (block 805). Contact with delete slider icon may be detected (block 810). For example, delete slider interface component 310 may detect contact in the area of touch screen 400 corresponding to delete slider icon 401. Block 805 of FIG. 8A corresponds to block 505 of FIG. 5 and block 810 of FIG. 8A corresponds to block 510 of FIG. 5. Blocks 805 and 810 are included in FIG. 8A for completeness.

In response to detecting contact with the delete slider icon, an indication may be provided of the contact with the delete slider icon (block 820). For example, delete slider interface component 310 may send a signal to the touch screen to change the appearance of delete slider icon 401 to highlighted delete slider icon 601. Alternatively or additionally, a unique audio signal may be provided.

A dragging action may be detected (block 830). For example, delete slider interface component 310 may detect that the user has dragged the delete slider icon after touching the delete slider icon and may activate delete on release component 330. Dragging may correspond to the user sliding the finger or pointing device without significantly releasing pressure. A user may drag the delete slider icon 401 across character entry box 815. The user may slide the delete slider icon in a horizontal direction or in a vertical direction. If a user slider the delete slider icon in a vertical direction, multiple rows of text may be selected for deletion.

In response to detecting that the user has begun to drag the delete slider icon, an indication of dragging action may be provided (block 840). For example, in one implementation, delete on release component 330 may change highlighted delete slider icon 601 to dragging delete slider icon 701. In another implementation, delete on release component 330 may maintain the appearance of the delete slider icon as highlighted delete icon 601 during the dragging action. Alternatively or additionally, a unique audio signal may be provided. As the user moves the delete slider icon across the display, the position of the delete slider icon is changed accordingly.

Contact of delete slider icon with displayed characters may be detected (block 850). For example, delete on release component 330 may detect that the current position of the delete slider icon coincides with a row of displayed characters. An indication of character being selected may be provided (block 880). For example, delete on release component 330 may turn a selected the row of characters into a highlighted row of characters 845. Alternatively or additionally, a unique audio signal may be provided.

Release of contact with the delete slider icon may be detected (block 870). For example, delete on release component 330 may detect that contact in the area of touch screen 400 corresponding to dragging delete slider icon 701 has ended. An indication of the selected characters being deleted may be provided (block 880). For example, delete on release component 330 may remove multiple rows of highlighted characters from text entry box 810. A difference between the process of FIGS. 8A and 8B and the process of FIGS. 7A and 7B may be that in the process of FIGS. 7A and 7B, characters may disappear before the delete slider icon is released, whereas in the process of FIGS. 8A and 8B, the characters do not disappear until the delete slider icon is released.

An animation of the delete slider icon returning may be provided (block 890). For example, delete on release component 330 may provide returning delete slider icon animation 785. Additionally, a unique audio signal may be provided. Delete slider icon may return to the starting position and remain there, since not all characters have been deleted. If all characters have been deleted, an animation of the delete slider icon disappearing may be provided (not shown). For example, delete on release component 330 may provide animation 795 of the delete slider sliding out of sight at the corner of text entry box 810.

### Flick to Delete Function

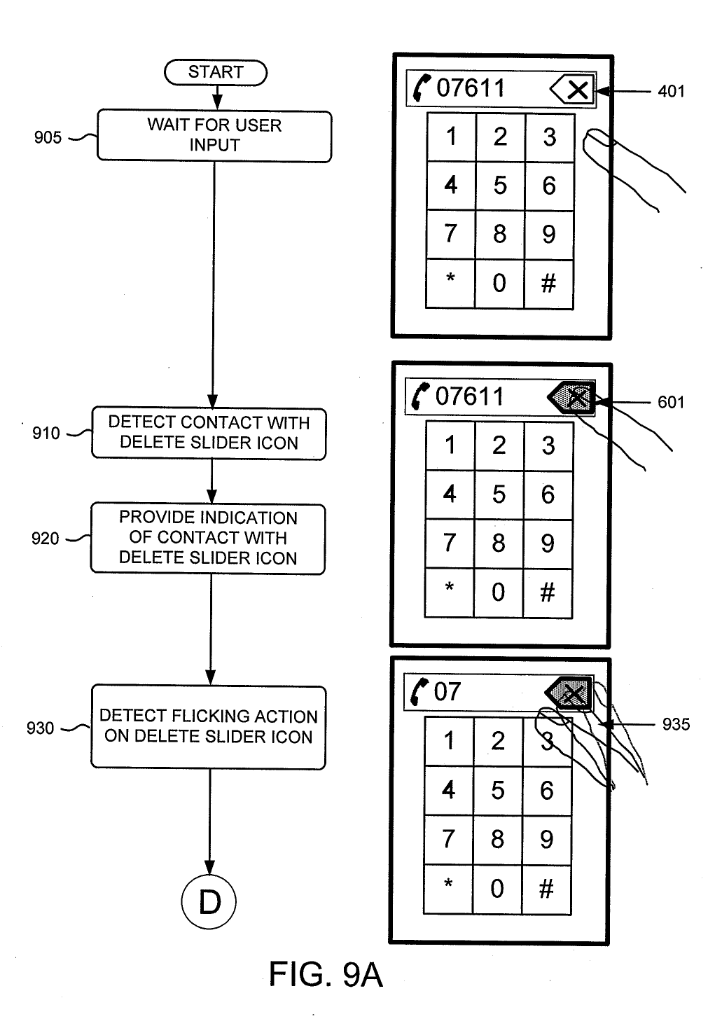

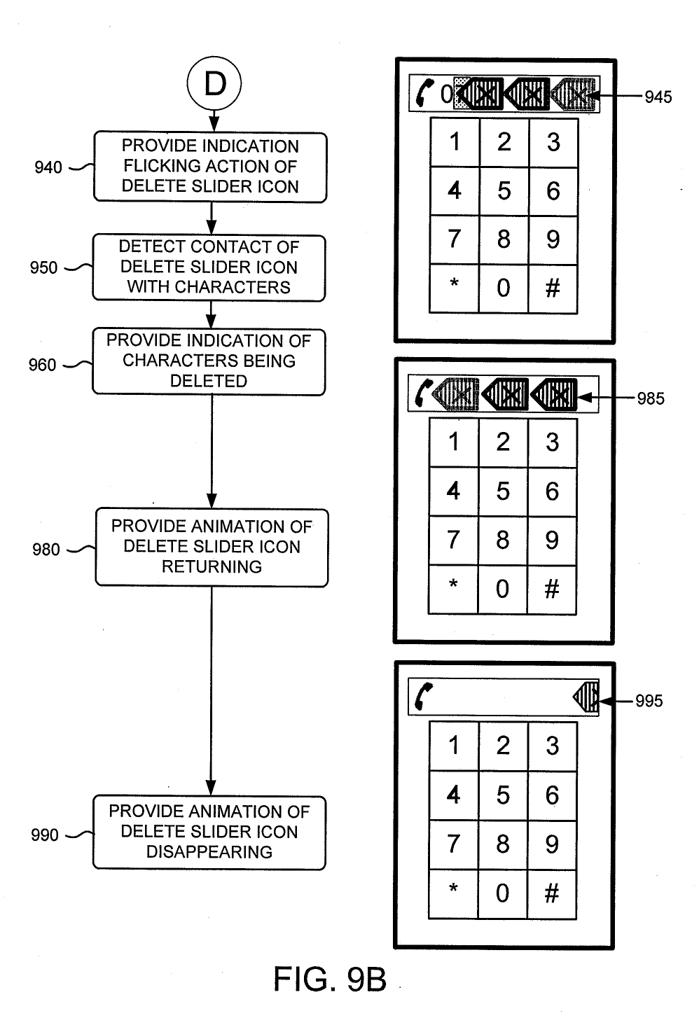

FIGS. 9A and 9B illustrate a flow graph of an exemplary process for implementing a flick to delete component of the delete slider mechanism. The process of FIG. 9A may begin with waiting for user input (block 905). Contact with delete slider icon may be detected (block 910). For example, delete slider interface component 310 may detect contact in the area of touch screen 400 corresponding to delete slider icon 401. Block 905 of FIG. 9A corresponds to block 505 of FIG. 5 and block 910 of FIG. 9A corresponds to block 510 of FIG. 5. Blocks 905 and 910 are included in FIG. 9A for completeness.

In response to detecting contact with the delete slider icon, an indication may be provided of the contact with the delete slider icon (block 920). For example, delete slider interface component 310 may send a signal to the touch screen to change the appearance of delete slider icon 401 to highlighted delete slider icon 601.

A flicking action may be detected (block 930). For example, delete slider interface component 310 may detect that the user has flicked the delete slider icon after touching the release slider contact. Flicking may correspond to the user moving the finger or pointing device with a short, quick movement. For example, a user may perform a flicking motion 935 to flick the highlighted delete slider icon 601 towards characters 415.

An indication of a flicked delete slider icon may be provided (block 940). For example, flick to delete component 340 may change the appearance of highlighted delete slider icon 601 to flicked delete slider icon animation 945. Flicked delete slider icon animation 945 may display the delete slider icon moving across character entry box 410 in a quick movement. Additionally, a unique audio signal may be provided.

As the flicked delete slider icon animation proceeds, contact of delete slider icon with displayed characters may be detected (block 950). For example, flick to delete component 330 may detect that the current position of the delete slider icon coincides with a displayed character. A displayed character that comes in contact with the delete slider may turn into highlighted character 655. An indication of a character being deleted may be provided (block 960). For example, flick to release component 330 may remove a character contacted by the delete slider from character entry box 410. The actions of blocks 950 and 960 proceeds until all characters have been deleted.

An animation of the flicked delete slider icon returning may be provided (block 980). For example, flick to delete component 340 may provide returning flicked delete slider icon animation 885. As all characters have been deleted, an animation of the delete slider icon disappearing may be provided (block 990). For example, flick to delete component 340 may provide animation 995 of the delete slider sliding out of sight at the edge of character entry box 410.

In one implementation, a flick to delete function may be implemented with multiple rows of text. When a user flicks the delete slider icon while multiple rows of text are displayed, the delete slider mechanism may delete all the text.

Additional functions may be implemented by the delete slider mechanism. For example, the delete slider mechanism may implement a repeating delete function. A repeating delete function may be activated in response to a “press and hold” action. If a user presses on the delete slider icon and maintains pressure for a particular period of time, a repeating delete action may be activated. The particular period of time may be 2 seconds, 3 seconds, or another period of time. The particular period of time may be configurable by the user. As the user maintains pressure on the delete slider icon, characters may be deleted sequentially, one at a time. When the user releases pressure from the delete slider icon, the delete slider mechanism may stop deleting characters.

### CONCLUSION

Implementations described here may provide a delete slider mechanism that allows a user to execute multiple delete functions through a delete slider icon displayed on a screen. The delete slider mechanism may provide a tap to delete function, which allows a user to delete a single character by tapping the delete slider icon. The delete slider mechanism may provide a delete on release function, which allows the user to drag the delete slider icon over multiple characters and release the delete slider icon to delete the multiple characters. The delete slider mechanism may provide a flick to delete function, which allows a user to delete all the characters that have been entered by a flicking action.

The foregoing description provides illustration and description, but is not intended to be exhaustive or to limit the invention to the precise form disclosed. Modifications and variations are possible in light of the above teachings or may be acquired from practice of the invention.

For example, while series of blocks have been described with respect to FIGS. 5, 6A-6B, 7A-7B, 8A-8B, and 9A-9B, the order of the blocks may be modified in other implementations. Further, non-dependent blocks may be performed in parallel.

Still further, aspects have been mainly described in the context of a mobile communication device. As discussed above, the device and methods described herein may be used with any type of device that includes an input device. It should also be understood that particular materials discussed above are exemplary only and other materials may be used in alternative implementations to generate the desired information.

It will be apparent that aspects, as described above, may be implemented in many different forms of software, firmware, and hardware in the implementations illustrated in the figures. The actual software code or specialized control hardware used to implement these aspects should not be construed as limiting. Thus, the operation and behavior of the aspects were described without reference to the specific software code—it being understood that software and control hardware could be designed to implement the aspects based on the description herein.

Further, certain aspects described herein may be implemented as “logic” that performs one or more functions. This logic may include hardware, such as a processor, microprocessor, an application specific integrated circuit or a field programmable gate array, or a combination of hardware and software.

It should be emphasized that the term “comprises/comprising” when used in this specification is taken to specify the presence of stated features, integers, steps, or components, but does not preclude the presence or addition of one or more other features, integers, steps, components, or groups thereof.

Even though particular combinations of features are recited in the claims and/or disclosed in the specification, these combinations are not intended to limit the invention. In fact, many of these features may be combined in ways not specifically recited in the claims and/or disclosed in the specification.

No element, act, or instruction used in the description of the present application should be construed as critical or essential to the invention unless explicitly described as such. Also, as used herein, the article “a” is intended to include one or more items. Where only one item is intended, the term “one” or similar language is used. Further, the phrase “based on,” as used herein is intended to mean “based, at least in part, on” unless explicitly stated otherwise.

What is claimed is:

1. A device, comprising:
a memory to store a plurality of instructions; and
a processor to execute instructions in the memory to:
provide, to a user, a delete slider icon,
detect user activity associated with the delete slider icon, and
determine one of a plurality of delete functions to activate based on the user activity, where the plurality of delete functions include at least two of:
a tap to delete function that deletes a single character in response to the user tapping the delete slider icon,
a delete on release function that deletes one or more characters in response to the user dragging the delete slider icon over the one or more characters and releasing the delete slider icon, or
a flick to delete function that deletes all displayed characters in response to the user flicking the delete slider icon.

2. The device of claim 1, where the delete slider icon is provided inside a character entry box.

3. The device of claim 2, where the delete slider icon disappears if there are no characters in the character entry box.

4. The device of claim 2, where the character entry box displays multiple rows of text.

5. The device of claim 4, where the delete on release function is implemented to delete multiple rows of text with one dragging motion.

6. The device of claim 1, where the appearance of the delete slider icon changes based on the delete function being activated.

7. The device of claim 1, where each of the plurality of delete functions is activated with a single movement of the delete slider icon.

8. The device of claim 1, further comprising:
a touch screen to:
display the delete slider icon, and
receive input from the user associated with the delete slider icon.

9. A method performed by a mobile communication device, the method comprising:
providing, by an output device of the mobile communication device, a delete slider icon;
receiving, by an input device of the mobile communication device, one or more characters;
selecting, by a processor of the mobile communication device, a delete function from a plurality of delete functions, based on user activity associated with the delete slider icon;
deleting, by the processor, a single character of the one or more characters when a tap on the delete slider icon is detected;
deleting, by the processor, one or more of the one or more characters when the delete slider icon is dragged over the one or more characters and released; and
deleting, by the processor, all of the one or more characters when a flicking of the delete slider icon is detected.

10. The method of claim 9, further comprising providing a different audible signal for each of the plurality of delete functions.

11. The method of claim 9, where an appearance of the delete slider icon changes based on the selected delete function.

12. The method of claim 9, where detection of the flicking of the delete slider icon comprises:
detecting a speed associated with a movement of the delete slider icon, and
detecting a distance associated with the movement of the delete slider icon before detecting a release of the delete slider icon.

13. The method of claim 12, where detecting a speed associated with the movement of the delete slider icon comprises detecting that the speed is greater than a first threshold and where detecting a distance associated with the movement of the delete slider icon comprises detecting that the distance is less than a second threshold.

14. The method of claim 9, further comprising providing a character entry box and where providing the delete slider icon comprises providing the delete slider icon inside the character entry box.

15. The method of claim 14, where the character entry box displays multiple rows of text.

16. The method of claim 9, where the deleting one or more of the one or more characters comprises deleting multiple rows of text based on a single dragging motion.

17. A computer-readable medium containing instructions executable by one or more processors, the computer-readable medium comprising:
one or more instructions to provide a delete slider icon;
one or more instructions to receive one or more characters;
one or more instructions to select a delete function based on user activity associated with the delete slider icon;
one or more instructions to delete a single character of the one or more characters when a tap on the delete slider icon is detected;
one or more instructions to delete one or more of the one or more characters when the delete slider icon is dragged over the one or more characters and released; and
one or more instructions to delete all of the one or more characters when a flicking of the delete slider icon is detected.

18. The computer-readable medium of claim 17, further comprising:
one or more instructions to remove the delete slider icon if all the received one or more characters are deleted.

19. The computer-readable medium of claim 17, further comprising:
one or more instructions to provide an animation of the delete slider icon returning to an original position after deleting at least two characters in a single action.

20. The computer-readable medium of claim 19, further comprising:
one or more instruction to provide an animation of the delete slider icon disappearing after deleting all of the one or more characters.
